(19) United States
(12) Patent Application Publication
(10) Pub. No.: US 2005/0254404 A1
(43) Pub. Date: Nov. 17, 2005

(54) Manufacturing method of stamper master disc to produce optical recording medium

(76) Inventor: Motohiro Furuki, Tokyo (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 11/124,699

(22) Filed: May 9, 2005

(30) Foreign Application Priority Data
May 17, 2004 (JP) 2004-146812

(51) Int. Cl. G11B 9/00; G11B 7/24

(52) U.S. Cl. 369/126; 369/275.1; 369/275.4

(57) ABSTRACT

When a stamper master disc 1 to produce an optical recording medium is manufactured, the concavities and convexities corresponding to the pits of a finally obtained optical recording medium are formed by recording compensation exposure pulses of a plurality of exposure pulses symmetrical to the center of the longitudinal direction of the pit. Thus, in the optical recording medium, a pit width difference produced by a difference of the pit lengths can be decreased.

### CROSS REFERENCES TO RELATED APPLICATIONS

The present invention contains subject matter related to Japanese Patent Application JP 2004-146812 filed in the Japanese Patent Office on May 17, 2004, the entire contents of which being incorporated herein by reference.

### BACKGROUND OF THE INVENTION

1. Field of the Invention

The present invention relates to a manufacturing method of a stamper master disc to produce an optical recording medium.

2. Description of the Related Art

FIG. 1 of the accompanying drawings is a schematic top view showing an optical recording medium, for example, an optical recording medium such as a CD-ROM (Compact Disc-Read Only Memory). As shown in FIG. 1, in this optical recording medium, concave and convex patterns such as tracking grooves and information pits are formed on the surface of a substrate of a disc or the surface of a resin layer formed on the substrate surface.

Concave and convex patterns are formed by a method using a stamper with an inverted pattern of a target concave and convex pattern as a mold stamper to mold a recording medium substrate by an injection molding process or as a press stamper in a so-called 2P (Photo Polymerization) method to press a resin coated on the recording medium substrate, that is, a suitable resin such as a ultraviolet-curing resin.

This stamper is produced as follows. That is, a master disc with a concave and convex pattern formed thereon is produced and a stamper is produced by transferring the concave and convex pattern formed on this master disc or it is produced by repeatedly transferring the concave and convex pattern after a father stamper was formed.

When a stamper master disc of a recording medium is manufactured, a novolac-based resist has so far been used as a mask for the etching process to form concavities and convexities on the substrate of the recording medium.

FIG. 2 is a schematic diagram showing an example of a characteristic curve useful for explaining sensitivity of a resist material. As shown in FIG. 2, sensitivity of the resist material is evaluated from a characteristic curve obtained by a logarithm of exposure and a remaining film rate and an inclination of a straight line portion of this characteristic curve is represented by γ.

The novolac-based resist has a very gentle γ so that a linear pattern is formed relative to illumination light and energy of illuminated electrons. That is, since the novolac-based resist can form a pattern based on the photon mode, the novolac-based resist has been used as the etching mask.

However, since reaction caused by irradiation of light or irradiation of electron beams in the novolac-based resin is not catalytic chain reaction caused by acid catalyst, for example, as will be described later on, the novolac-based resist needs a large amount of photo-initiators having an absorption wavelength band in a short wavelength region, that is, ultraviolet radiation region and hence it may not be resolved even by using ultraviolet laser light. Accordingly, the novolac-based resist is low in resolution and hence it is difficult to improve a recording density of the recording medium when the stamper master disc is manufactured by using the novolac-based resist.

For this reason, in recent years, it has been tried to manufacture a stamper master disc for an optical recording medium by using a chemically amplified resist which is becoming the mainstream of resist in the semiconductor process.

The chemically amplified resist is caused to change dissolution relative to developer by acid catalyst reaction and it has properties capable of varying dissolution relative to the developer when acid acts as a catalyst to cause a large number of chemical reactions after the acid was generated by exposure to the resist.

Also, the chemically amplified resist has the steep inclination of the above-mentioned sensitivity characteristic curve, and it is known that fluctuation of sensitivity of the chemically amplified resist becomes the extreme as the value γ representative of the above-mentioned inclination becomes unsuitable as a parameter representing resist sensitivity of the chemically amplified resist(see Cited Non-patent Reference 1, for example).

The reason for this is that a chemical reaction is suddenly accelerated by occurrence of acid and heat in addition to the fact that the above-mentioned chemically amplified resist is high in sensitivity and resolution. Thus, when the resist is exposed by exposure exceeding a specific threshold value, a remaining film rate is suddenly decreased and it becomes approximately 0 (zero) so that the pattern is formed.

However, when the chemically amplified resist is formed, even if a quantum yield of a reaction itself directly caused by exposure is low, it gives rise to so-called acid catalytic chain reaction which causes a large number of reactions with heat, and hence an effective quantum yield may make a rapid increase. Also, since the chemically amplified resist needs an extremely small quantity of photo-initiator, its transmittance in the short wavelength region is increased as compared with that of the novolac-based resist, and hence the chemically amplified resist can be resolved by ultraviolet laser light, for example.

For this reason, the chemically amplified resist is high in resolution and sensitivity as compared with the novolac-based resist. Thus, it is considered that, when the stamper master disc is manufactured by using the chemically amplified resist, it is possible to improve a recording density of an optical recording medium, for example, an optical disc, an optical card and the like.

[Cited Non-patent Reference 1]: Jpn. J. appl. Phys. Vol. 31 (1992), pp. 4294-4300, Part 1, No. 12B, December, 1992

Let us now consider a pit length in a pit pattern of an optical recording medium. In the case of an optical recording medium with a recording capacity of 25 GB according to 1-7PP (Parity Preserve) modulation system, while a shortest pit length is 149 nm, a longest pit length is 596 nm and a large difference lies between both of the shortest pit length of 149 nm and the longest pit length of 596 nm.

Accordingly, when the concavities and convexities corresponding to these pits are simply formed on the stamper master disc, depending on a correlation of length and width, the length of pit is increased and the increase of width of pit also is promoted. Also, in the chemically amplified resist, since the number of acids generated by exposure is substantially in proportion to the length of the above-mentioned concavities and convexities, the concavities and convexities corresponding to the long pit are increased in width and hence a difference between the pit width of the shortest pit and the pit width of the longest pit is increased more in the finally obtained optical recording medium.

Thus, when the stamper master disc is manufactured under exposure condition and heating condition suitable for forming the shortest pit, the pits are brought in contact with each other around the pit having a large pit length. Also, when the stamper master disc is manufactured under exposure condition and heating condition suitable for forming the longest pit, it becomes impossible to form a pit having a small pit length stably. As a result, in any cases, various problems arise, in which the pattern becomes defective, jitter is deteriorated and in which an error rate is increased.

FIG. 3A is a microscopic representation of a pit with a pit length 11T, which is the shortest pit length according to the existing standards, of an optical recording medium manufactured from a master disc produced with irradiation of electron beams with irradiation power of 6.23 nC/m according to the related-art stamper master disc manufacturing method. In the optical recording medium produced from the master disc manufactured with this electron beam irradiation power, the longest pit might be formed properly but a short pit such as a pit with a pit length 3T might not be formed stably.

Therefore, in an optical recording medium produced from a master disc produced with increased electron beam irradiation power of 6.9 nC/m, at that time point, there was obtained a result in which the pits are brought in contact with each other as shown by a broken line a in FIG. 3B.

Then, in an optical recording medium produced from a master disc manufactured with much more increased electron beam irradiation power of 7.4 nC/m, it was visually confirmed that the pits are frequently brought in contact with each other as shown by a broken line b in FIG. 3C.

Also, when a dry etching process based on a RIE (Reactive Ion Etching) method is applied to the substrate of an optical recording medium after a chemically amplified resist was formed on the substrate surface of a stamper master disc and the concavities and convexities corresponding to the pits of a finally obtained optical recording medium were formed on the substrate by using the chemically amplified resist formed on the substrate surface of the stamper master disc as the etching mask, the pits of any sizes are similarly reduced in size. That is, when a degree of modulation of the shortest pit may be expressed as 2T/8T, a degree of modulation of the shortest pit becomes (2T-Δ)/(8T-Δ). Hence, the degree of modulation of the shortest pit becomes larger than a degree of modulation of a relatively long pit in decreased width.

When the lengths of the pits formed on the optical recording medium with a recording capacity corresponding to 150 GB obtained before and after the dry etching process based on the RIE method are contrasted with each other as shown in FIGS. 4A and 4B, as it is clear from FIG. 5 which shows measured results obtained when the pit widths were changed by the dry etching process, with respect to the pit widths of the shortest pit and the longest pit, the pit widths are decreased 25 nm, in this example, by the dry etching process regardless of the length of the pit lengths.

More specifically, in the above-mentioned exposure conditions and heating conditions, even when conditions under which both of the shortest pit and the longest pit can be manufactured are discovered, it is not possible to sufficiently suppress characteristics from becoming different from each other due to the difference between the pit lengths. As a consequence, the asymmetry of reproduced waveform is shifted considerably, the jitter is deteriorated and the error rate is increased unavoidably.

Accordingly, it is requested to provide a pit forming method in which a characteristic difference between the pits can be prevented from being produced due to the pit size not only in the process for forming the pits but also in the process required after the pits were formed.

More specifically, as compared with the optical recording medium produced from the stamper master disc manufactured by the novolac-based resist, the optical recording medium produced by using the stamper master disc manufactured by the chemically amplified resist is extremely large in asymmetry of reproduced waveform. Furthermore, there arises a problem, in which the jitter is deteriorated by the increase of the asymmetry of the reproduced waveform.

### SUMMARY OF THE INVENTION

In view of the aforesaid aspects, the present invention is intended to solve the above-mentioned problems encountered with the manufacturing method of the stamper master disc to produce a recording medium, for example, an optical recording medium.

According to an aspect of the present invention, there is provided a manufacturing method of a stamper master disc to produce an optical recording medium on which concave and convex patterns including at least information pits are formed. This manufacturing method is provided with the steps of a resist layer forming process for forming an electron beam photosensitive type chemically amplified resist layer on a substrate, an electron beam irradiation process for exposing the resist layer with irradiation of electron beams of an electron beam lithography pattern corresponding to the concave and convex patterns and a developing treatment process for patterning the chemically amplified resist layer by developing the chemically amplified resist layer, wherein electron beam lithography with respect to at least a part of the pits of the concave and convex pattern in the electron beam irradiation process is carried out by recording compensation exposure pulse based on a plurality of exposure pulses symmetrical to a center of the longitudinal direction of the pit.

In the manufacturing method of a stamper master disc to produce an optical recording medium according to the present invention, the exposure pulse in the electron beam irradiation has a constant voltage.

In the manufacturing method of a stamper master disc to produce an optical recording medium according to the present invention, the electron beam irradiation process is carried out by using a local vacuum electron beam lithography system.

Further, in the manufacturing method of a stamper master disc to produce an optical recording medium according to the present invention, the exposure pulse is less than a shortest recording pit length.

Furthermore, in the manufacturing method of a stamper master disc according to the present invention, the exposure pulse has a space less than ⅓ of a shortest recording pit width.

According to the manufacturing method of a stamper master disc to produce an optical recording medium of the present invention, since the concavities and convexities corresponding to the pits of the finally obtained optical recording medium are formed by recording compensation exposure pulses based on a plurality of pulses symmetric to the longitudinal direction, the widths of the concavities and convexities of the stamper master disc can be made substantially constant regardless of the length of the pit.

Also, when these concavities and convexities are formed, since the voltage to make exposure, that is, the voltage required by electron beam irradiation is made constant, the exposure pulse is selected to be less than the shortest recording pit length of the standards of the recording medium and the exposure pulse interval is selected to be less than ⅓ of the width of the shortest recording pit, it is possible to especially properly form the concavities and convexities by which a recording pit of target size and shape can be formed accurately.

Accordingly, since a difference between the pit widths of the finally obtained optical recording medium can be decreased, it is possible to decrease problems such as the pattern failure, the increase of the asymmetry of the reproduced signal, the deterioration of the jitter and the increase of the error rate.

Also, according to the manufacturing method of the stamper master disc to produce the optical recording medium of the present invention, when the chemically amplified resist formed on the surface of the substrate of the stamper master disc is used as the etching mask to form respective concavities and convexities corresponding to the pits of the finally obtained optical recording medium on the substrate surface and the dry etching process based on the RIE (Reactive Ion Etching) method is applied to the optical recording medium thus obtained by this master disc, it is possible to alleviate a difference produced between the decreased widths of degree of modulations due to the lengths of pits by methods such as to make the lengths of pulses constructing respective concavities and convexities become uniform or to set a voltage to be high in advance with respect to a shorter pulse to increase the width of the pulse.

Accordingly, it is possible to avoid a difference from being produced between the characteristics of the pits due to the difference of the pit lengths not only in the process for forming the pits but also in the process required after the pits were formed.

More specifically, in the exposure conditions and the heating conditions, when the conditions for making the shortest pit and the longest pit become compatible with each other are discovered, it is possible to sufficiently suppress a difference of characteristics from being produced due to the difference between the pit lengths with application of the present invention. As a result, the increase of the asymmetry of the reproduced signal, the deterioration of the jitter and the increase of the error rate can be improved and hence many important effects can be achieved by the manufacturing method of the present invention.

### BRIEF DESCRIPTION OF THE DRAWINGS

FIG. 1 is a schematic top view showing a disc-like optical recording medium according to the related art;

FIG. 2 is a diagram of a characteristic curve to which reference will be made in explaining sensitivity of a resist material according to the related art;

FIGS. 3A to 3C are top views (microscopic representations) showing optical recording mediums manufactured based on a stamper master disc manufacturing method according to the related art in an enlarged scale, respectively;

FIGS. 4A and 4B are top views (microscopic representations) showing optical recording mediums manufactured based on a stamper master disc manufacturing method according to the related art in an enlarged-scale, respectively and which are obtained before and after the dry etching process is made based on a RIE (reactive ion etching) method;

FIG. 5 is a schematic diagram showing the manner in which pit widths are changed with pit lengths before and after the dry etching process is effected on the optical recording medium produced by the stamper master disc manufacturing method according to the related art;

FIGS. 6A to 6D are respectively process diagrams of cross-sections of finally obtained optical recording mediums and which show the processes of a manufacturing method of a stamper master disc to produce an optical recording medium according to an embodiment of the present invention;

FIG. 7 is a schematic diagram of an arrangement showing an example of an electron beam lithography system suitable for use with a manufacturing method of a stamper master disc to produce an optical recording medium according to the present invention;

FIG. 8 is a schematic diagram of an arrangement showing the layout of electrodes of the electron beam lithography system;

FIGS. 9A and 9B are schematic diagrams showing main portions of an example of a manufacturing apparatus for use with a manufacturing method according to the present invention, that is, examples of the layout of a blanking stop and a blanking plate constituting a lens-barrel, respectively;

FIGS. 10A and 10B are respectively top views (microscopic representations) showing, in an enlarged-scale, the pits in an optical recording medium produced from a stamper master disc manufactured by a manufacturing method of a stamper master disc to produce an optical recording medium according to the present invention;

FIG. 11 is a schematic diagram showing the manner in which a pit width of a pit length 11T is changed relative to a probe current in the optical recording medium produced based on the manufacturing method of the stamper master disc to produce the optical recording medium according to the present invention and in the optical recording medium produced based on a manufacturing method of a stamper master disc according to the related art, respectively;

FIG. 12 is a schematic diagram showing the manner in which pit widths are changed relative to pit lengths (3T to 11T) in the optical recording medium produced based on the manufacturing method of the stamper master disc to produce the optical recording medium according to the present invention and in the optical recording medium produced based on the manufacturing method of a stamper master disc according to the related art;

FIG. 13A is a schematic diagram of a pulse strategy in an example of an optical recording medium produced based on a manufacturing method of a stamper master disc to produce an optical recording medium according to the present invention;

FIG. 13B is a top view (microscopic representation) showing this optical recording medium in an enlarged-scale;

FIG. 14A is a schematic diagram of a pulse strategy in a comparative example of an optical recording medium produced based on a manufacturing method of a stamper master disc to produce an optical recording medium according to the present invention;

FIG. 14B is a top view (microscopic representation) showing this optical recording medium in an enlarged-scale;

FIG. 15A is a schematic diagram of a pulse strategy in a comparative example of an optical recording medium produced based on a manufacturing method of a stamper master disc to produce an optical recording medium according to the present invention; and

FIG. 15B is a top view (microscopic representation) showing this optical recording medium in an enlarged-scale.

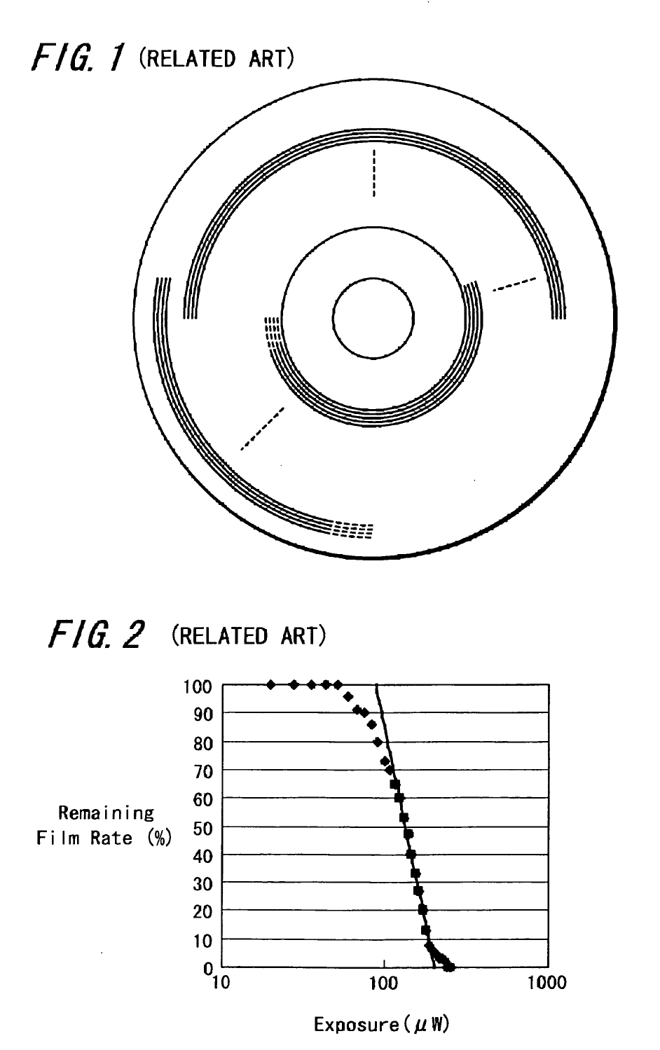

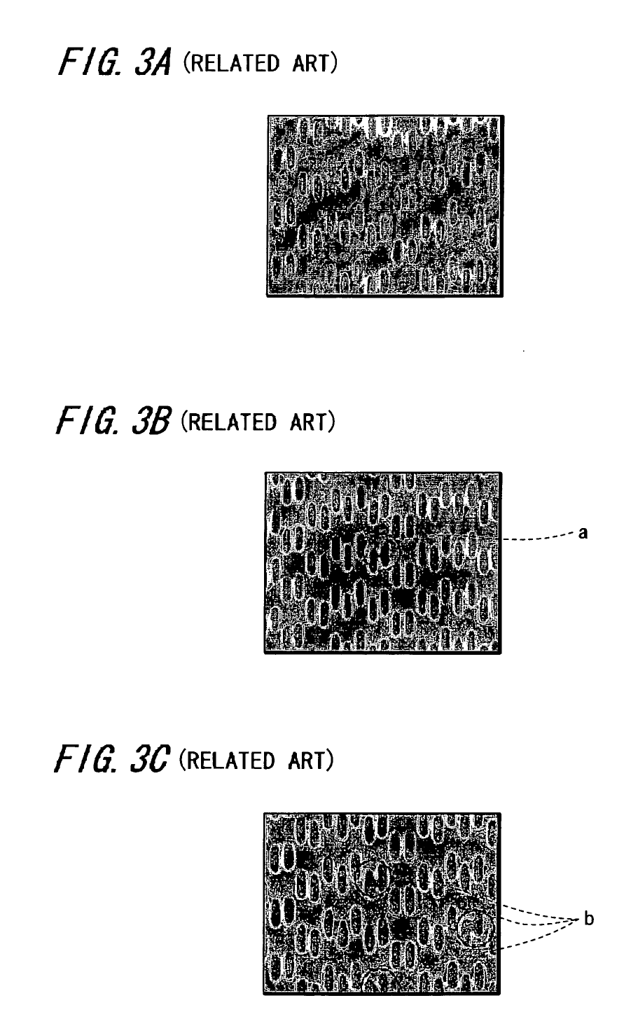

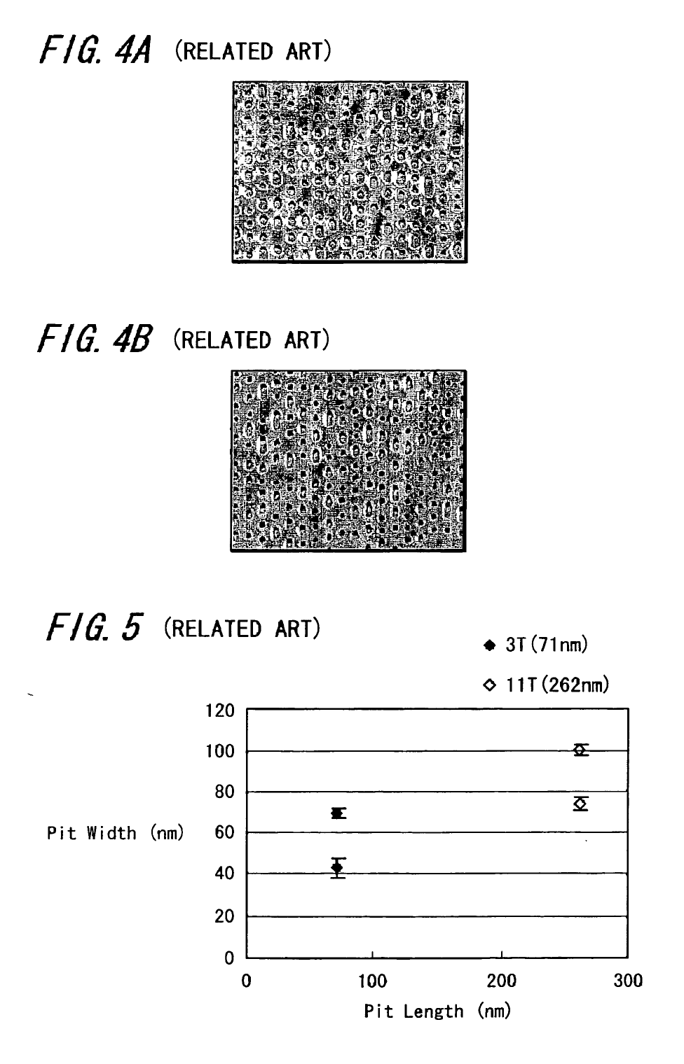

### DESCRIPTION OF THE PREFERRED EMBODIMENTS

The embodiments of the present invention will be described below in detail with reference to the drawings, and it is needless to say that the present invention is not limited to the following embodiments.

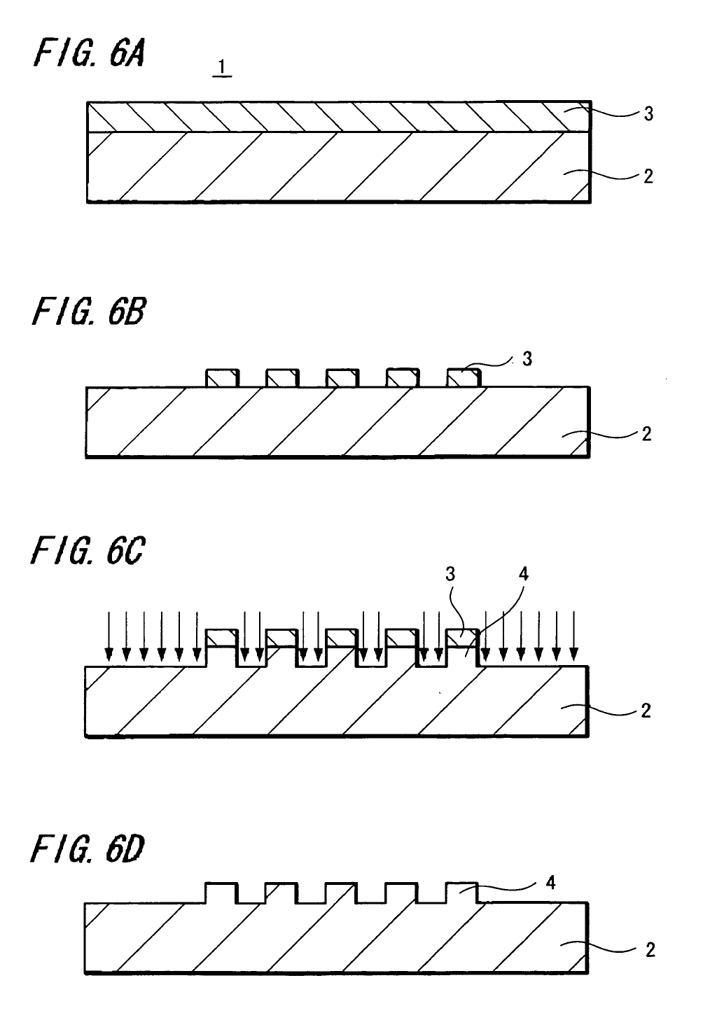

An outline of the procedures of a manufacturing method of a master disc to produce an optical recording medium will be described with reference to the process diagrams of FIGS. 6A to 6D.

First, as shown in FIG. 6A, there is prepared a substrate 2 of a master disc 1 made of a suitable material, which is difficult to be charged with illumination of electron beams, which will be described later on, such as a silicon semiconductor substrate. Then, a resist layer 3, which is exposed by electron beams, is coated and formed on this substrate 2 by a suitable method such as a spin coat method.

A chemically amplified positive resist may be suitable for use as this resist layer 3.

Next, focusing electron beams are irradiated on the resist layer 3 spirally or concentrically by using an electron beam lithography system while the focusing electron beams are being modulated in response to a recording signal, whereby concavities and convexities corresponding to the concave and convex pattern in the finally formed optical recording medium are exposed on the resist layer 3.

After that, a PEB (Post Exposure Bake) process corresponding to the necessity is effected on this resist layer 3 and the resultant resist layer 3 is treated by an exclusive-use developer and thereby it is patterned so as to leave the portions corresponding to the convex portions of the concave and convex pattern of the finally formed optical recording medium, that is, information pits and grooves, for example, as shown in FIG. 6B.

As shown in FIG. 6C, while the resist layer 3 formed on the substrate 2 is being used as the etching mask, silicon (Si) is etched away to the depth of approximately 80 nm by the RIE method in the atmosphere of flon-based gas such as CF₄ gas and CHF₃ gas or Cl-based gas such as Cl₂ gas, whereby a concave and convex pattern 4 is formed on the surface of the substrate 2.

The thus formed concave and convex pattern 4 becomes a pattern in which the convex portions of the concave and convex pattern of the finally formed optical recording medium are used as the pits.

Then, by using the thus obtained master disc 1, a target stamper is manufactured by repeatedly transferring the concave and convex pattern necessary times.

The master disc is manufactured in this manner. Particularly, according to the present invention, as will be described later on, the resist layer 3 is treated by the electron beam lithography with a plurality of exposure pulses symmetric to the longitudinal direction of the pit under a constant voltage, that is, under a constant energy of electron beams, for example.

A magnitude of a voltage in the electron beam lithography affects an effective stop speed of electron beams required when the voltage is switched from ON to OFF upon switching of ON/OFF of electron beams, which will be described later on, that is, when the voltage is set to 0V. Accordingly, in the manufacturing method of the stamper master disc to produce the optical recording medium according to the present invention, since the magnitude of the voltage causes the exposure pulse interval to be fluctuated, excepting the case in which laser light is modulated, by selecting a voltage to be constant, it is to be desired that the fluctuation of the exposure pulse interval in the pulse exposure, which will be described later on, should be avoided and that satisfactory pulse exposure and a satisfactory concave and convex pattern should be formed.

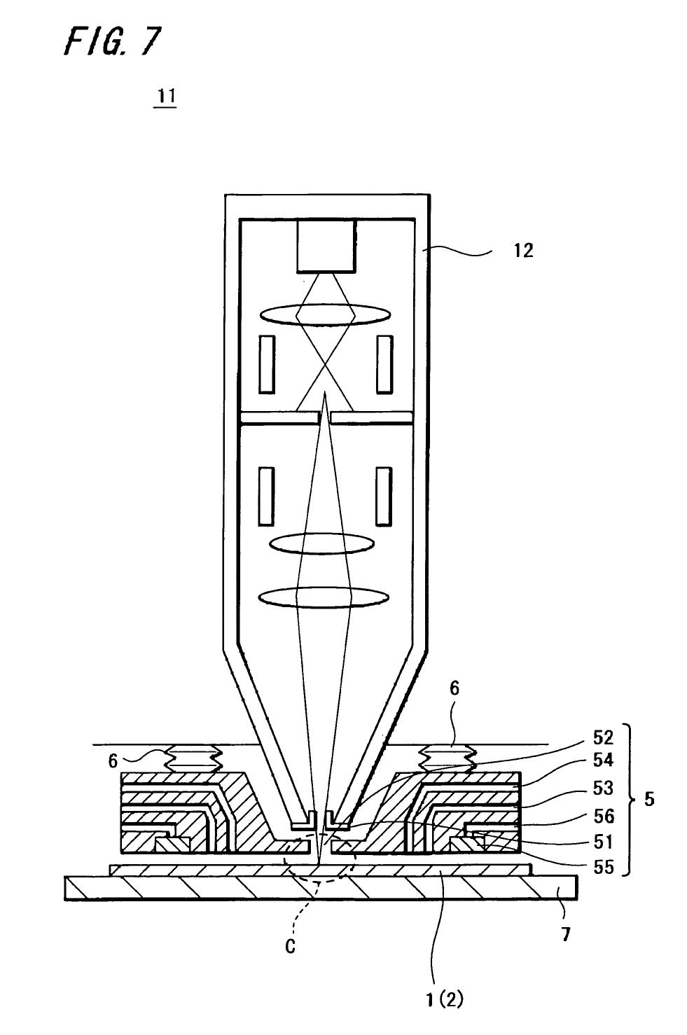

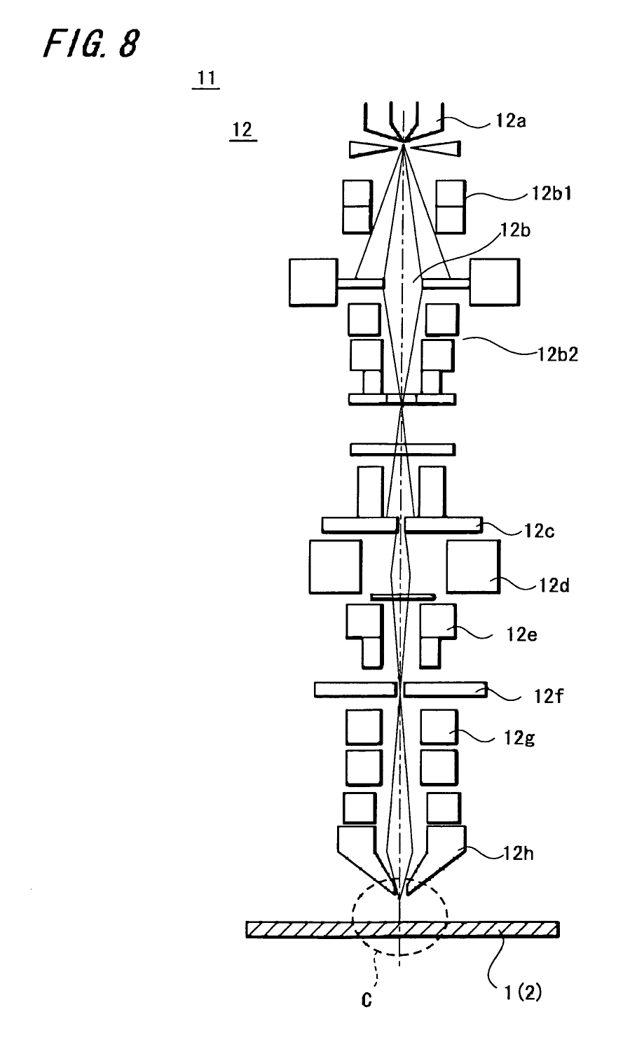

Next, in the embodiments of the manufacturing method according to the present invention, an example of an electron beam lithography system for use in the present invention will be described with reference to FIGS. 7 and 8.

In the manufacturing method according to the present invention, it is to be desired that a local vacuum electron beam lithography system for locally holding an electron beam path portion toward the electron beam irradiated portion in the vacuum state should be used as the electron beam lithography system.

FIG. 7 is a schematic diagram of an arrangement showing an example of a local vacuum electron beam lithography system 11.

As shown in FIG. 7, this local vacuum electron beam lithography system 11 includes an illumination lens-barrel (EB column) 12, a differential exhaust flying head 5 and a supporting member 7 for supporting the substrate 2, that is, the electron beam irradiated material.

On the supporting member 7, there is located the substrate 2 coated with the aforementioned chemically amplified resist 3. The supporting member 7 is constructed in such a manner that it may be moved along the surface perpendicular to the optical axis of electron beams from the EB column 12, and hence electron beams from the EB column 12 can scan and expose the chemically amplified resist 3.

FIG. 8 is a schematic diagram of an arrangement showing an example of the EB column 12 more in detail.

As shown in FIG. 8, this EB column 12 includes an electron source 12a for emitting electron beams and various parts for controlling the electron beams emitted from the electron source 12a, such as first and second condenser lenses 12b1 and 12b2, an aperture 12b, an objective stop 12c, an intermediate lens 12d, a blanking plate 12e, a blanking stop 12f, a blanking plate 12g and an objective lens 12h.

Electron beams emitted from the electron source 12a are focused by the condenser lenses 12b1 and 12b2 to thereby form a first cross-over point. Since intensity of the electron beams is determined by a density of electrons, it is possible to adjust a quantity of electrons through the objective stop 12c by adjusting an angular aperture of the condenser lens 12b.

Subsequently, the electron beams passed through the objective stop 12c are focused by the intermediate lens 12d to form a second cross-over point at the blanking stop 12f. The blanking stop 12f sandwiched between the blanking plate 12e and the blanking plate 12g is located around the cross-over point and the ON/OFF of the electron beams can be switched at high speed by energizing this blanking stop 12f so as to operate at high speed, thereby making the pulse exposure become possible.

Since the electron source 12a is not a point source strictly, when the angular aperture of the above-mentioned condenser lens 12b is changed, it is unavoidable that a focus point on the substrate 2 is displaced. To avoid the displacement of the focus point on the substrate 2, such displacement may be corrected by the objective lens 12h and thereby defocusing can be prevented.

On the other hand, the differential exhaust flying head 5 has airtightness held between it and the EB column 12 by an expansion coupling mechanism 6 such as a bellows and it can also be moved very small amount in the upper and lower direction along the axis of the EB column 12.

For example, as shown in FIG. 7, the differential exhaust flying head 5 includes an electron beam passing aperture 52 opposing an electron beam emitting aperture 51 of the EB column 12 at the central axis of the axis of the EB column 12. Then, first and second gas suction inlets 53 and 54 opened toward the opposing face of the substrate 1 located on the supporting member 7, that is, the electron beam irradiated material at the outer periphery of the differential exhaust flying head 5 and a gas supply outlet 56 having a vent pad 55 are intermittently located on the concentric circumferences around the central axis of the differential exhaust flying head 5, respectively.

These first and second gas suction inlets 53 and 54 are respectively coupled through air holes penetrated within the differential exhaust flying head 5 to an exhaust means having a vacuum capability of 10⁻⁸ Pa, such as a cryopump, a turbo-molecular pump and an ion sputter pump capable of providing high degrees of vacuum and thereby they are exhausted respectively to evacuate the electron beam path to a degree of vacuum of approximately 1×10⁻⁴ Pa.

The degrees of vacuum in these gas suction inlets 53 and 54 are increased much as they are located closer to the side of the electron beam passing aperture 52. For example, in the illustrated example, the exhaust means may be coupled to the first and second gas suction inlets 53 and 54 such that the first gas suction inlet 53 may have a degree of vacuum of about 1×10⁰ Pa and that the second gas suction inlet 54 may have a degree of vacuum of about 1×10² Pa.

On the other hand, the gas supply inlet 56 with the vent pad 55 serving as a static pressure flying means are coupled with a compressed gas supply source through an air hole penetrated within the differential exhaust flying head 5. The compressed gas supply source may supply compressed gas of 5×10⁵ Pa.

It is to be desired that nitrogen gas or inert gas such as light-weight helium (He) gas, neon (Ne) gas and argon (Ar) gas should be used as this gas.

In this arrangement, owing to the suctions of the first and second gas suction inlets 53 and 54 and selection of supplying of gas from the gas supply outlet 56, that is, a differential pressure, the differential exhaust flying head 5 can be floated from the substrate 2 opposed to the differential exhaust flying head 5, that is, the surface of the electron beam irradiated material with a space of several micrometers, for example, 5 μm, that is, differential exhaust flying head 5 may be opposed to the surface of the electron beam irradiated material in a non-contact fashion.

Also, at the same time, by intake, that is, exhaust made from the space between the differential exhaust flying head 5 and the electron beam irradiated material, that is, the substrate by the first and second gas suction inlets 53 and 54, vacuum seal may be made and hence the electron beam path near the electron beam passing aperture 52 in the inside of the portion in which these first and second suction inlets 53 and 54 are located and which lies in the area encircled by a broken line c may be evacuated.

The resist layer 3 formed on the substrate 2 is exposed with exposure pulses and the master disc is manufactured, that is, mastering is carried out by using the above-mentioned local vacuum electron beam lithography system 11.

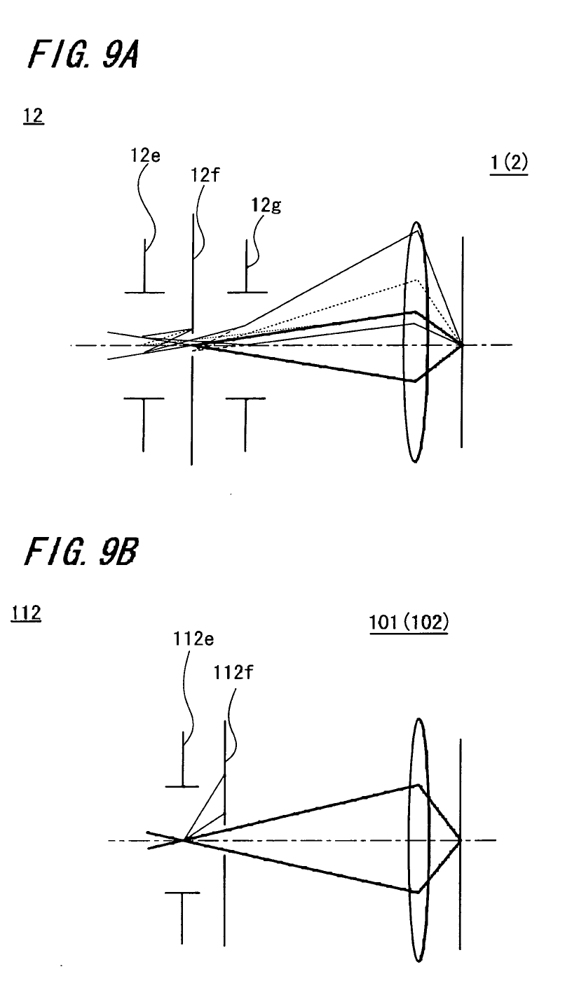

FIGS. 9A and 9B are schematic diagrams showing examples of the layout of the blanking stop and the blanking plate constituting the main portion of the manufacturing apparatus, that is, the lens-barrel portion, respectively.

As shown in FIG. 9A, two blanking plates 12e and 12g are located successively with respect to the direction through which electron beams are passed. Although this arrangement shown in FIG. 9A becomes complex in structure as compared with the arrangement in which there is provided one blanking plate 12e as shown in FIG. 9B, the arrangement shown in FIG. 9A enables the blanking stop 12f to carry out the above-mentioned operation at high speed and hence it is suitable for use as the application to the recording compensation exposure pulse in the manufacturing method of the present invention.

A stamper master disc was manufactured by using the manufacturing apparatus having this arrangement and an optical recording medium was manufactured. By way of example, a chemically amplified resist (manufactured by FUJIFILM ARCH CO., LTD., under the trade name of “EEP171”) having a thickness of 70 nm was coated on the surface of an Si (silicon) substrate with a diameter of 8-inches and a thickness of 0.725 mm. The resultant product was exposed with an acceleration voltage of 15 kV by the above-mentioned manufacturing apparatus, that is, the local vacuum electron beam lithography system and it is baked at 110° C. for 90 seconds in a PEB (Post Exposure Bake) fashion, whereafter the resultant product was developed for 20 seconds by an organic alkaline developer (manufactured by TOKYO OHKA KOGYO CO., LTD., under the trade name of “NMD-3”) and thereby miniscule concavities and convexities were formed on the surface of the substrate of the master disc.

In this embodiment, this optical recording medium has a track pitch of 160 nm, an exposure linear velocity of 1.19 m/s and an EFM (Eight to Fourteen Modulation)+recording modulation system. A recording density thereof is 10⁴ GB/in² and this is equivalent to a recording capacity of 150 GB of an optical recording medium with a diameter of 12 cm.

In this recording specification, 1T=23.8 nm is established, the shortest pit length is given as 3T=23.8×3=71.4 nm and the longest pit length is given as 11T=23.8×11=261.8 nm. While the shortest pit length (3T) is being used as a standard, concavities and convexities corresponding to the pits of the finally obtained optical recording medium were formed on the master disc at an electric current value of 10 nA by the maximum recording compensation pulse exposure.

An example in which the longest pit (11T) of this standard was formed by symmetric pulse exposure pattern of 11T=3T(ON)−1T(OFF)−3T(ON)−1T(OFF)−3T(ON) at the pulse voltage of 0V(OFF)−1V(ON) in the above-mentioned manufacturing apparatus will be described below.

While the case in which the longest pit of 11T is formed will be described in this embodiment, respective pits corresponding to 4T to 10T may be formed by combining a plurality of pulses less than the shortest length pit 3T in the longitudinal direction of the pits, that is, in the time base direction symmetric to the direction in which the optical recording medium is exposed and in which reproducing light is irradiated. Preferably, the exposure pulse interval, that is, the length of 0V(OFF) should be selected to be less than ⅓ of the pit length 3T, in this example, it should be selected to be less than 1T.

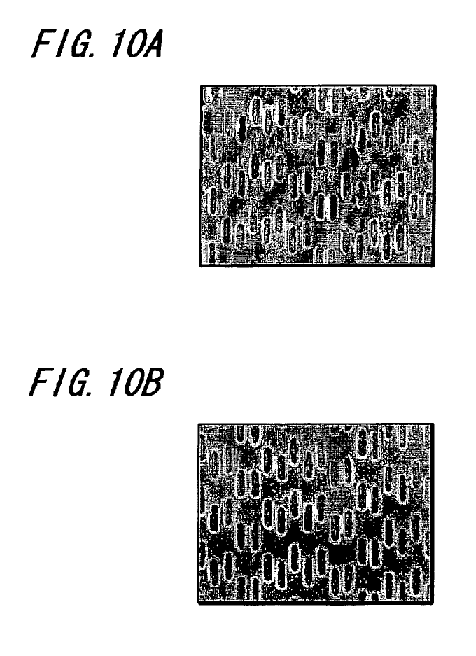

FIGS. 10A and 10B are top views (microscopic representations) of the pits of the optical recording medium produced from the stamper master disc obtained by the manufacturing method of the present invention in an enlarged-scale, respectively.

FIG. 10A shows the optical recording medium produced from the master disc which was manufactured at electron beam irradiation power of 6.9 nC/m, and FIG. 10B shows the optical recording medium produced from the master disc which was manufactured at electron beam irradiation power of 7.4 nC/m. Unlike the above-mentioned related-art manufacturing method, according to any one of the above-mentioned electron beam irradiation powers of 6.9 nC/m and 7.4 nC/m, the pits could be prevented from contacting with each other and hence the pits could be formed stably.

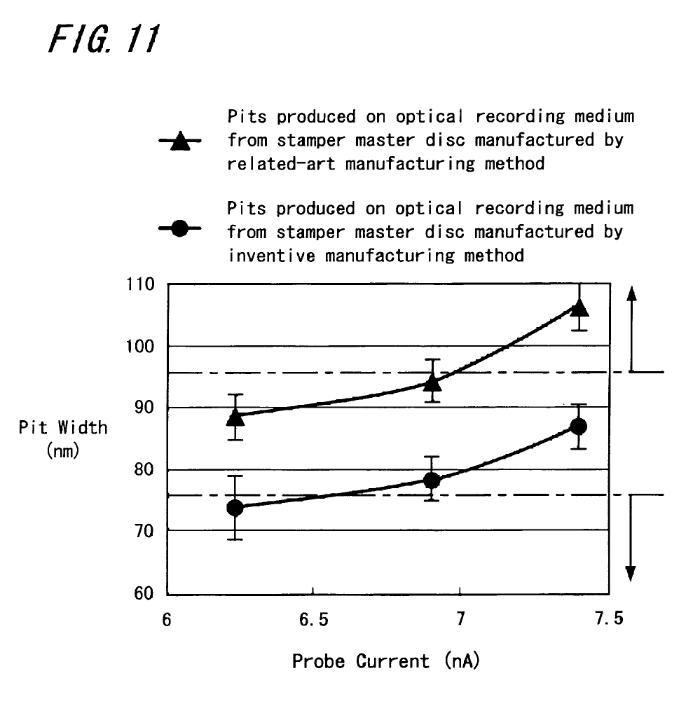

FIG. 11 is a diagram showing characteristic curves obtained when pit widths at each probe current were measured in the state in which the pits (11T; pit length is 262 nm) of the optical recording medium manufactured by using the stamper master disc manufactured by the manufacturing method according to the present invention were irradiated with electron beams.

A study of FIG. 11 reveals that the pit width, in particular, on the side of high electric current values can be formed within the standard as compared with those of the optical recording medium manufactured by the related-art manufacturing method.

From the measured results of FIG. 11, it can be considered that the pit width can be formed constant regardless of the pit length by forming respective pits based on designs of pulse strategy, that is, designs to control pulse exposure made on the respective pit lengths 3T to 11T.

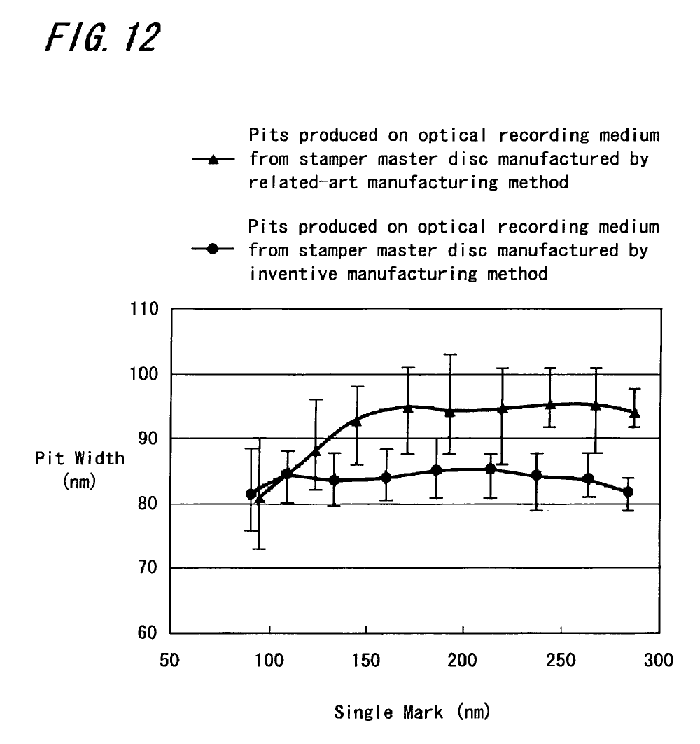

FIG. 12 is a diagram showing characteristic curves obtained when pit widths of respective pits of the pit lengths 3T to 11T were measured with respect to the optical recording medium obtained from a master disc after the master disc has been manufactured based on the pulse strategy design by the manufacturing method of the present invention.

From the measured results of FIG. 12, it could be confirmed that the pulse width of the optical recording medium manufactured by the manufacturing method of the present invention was substantially constant regardless of the pit length (single mark) as compared with the optical recording medium manufactured by the related-art master disc manufacturing method.

Also, in the optical recording medium produced from the master disc manufactured by the manufacturing method of the present invention, the pit width can be decreased about 20% and a process margin can be improved. From the above-mentioned results, it can be considered that the asymmetry of the optical recording medium can be decreased and that the jitter can be improved according to the present invention.

In this embodiment, the following table 1 shows the pit lengths of the optical recording medium produced by using the master disc manufactured by the related-art manufacturing method which does not use the recording compensation pulse exposure. The following table 2 shows pits and examples of pulse strategies of the optical recording medium produced by the master disc manufactured by the manufacturing method according to the present invention using the recording compensation pulse exposure. As shown on the table 2, all pit lengths (3T to 11T) are formed by combining a plurality of pulse exposures less than the pit length 3T of the shortest pulse in the longitudinal direction of the pit, that is, in the direction symmetric to the direction in which the optical recording medium is exposed and the time base direction in which reproducing light is irradiated, that is, in the direction symmetric to the center of the longitudinal direction. Also, the pulse interval, that is, the length of 0V(OFF) is selected to be less than ⅓ of the pit length 3T of the shortest pulse, in this example, it is selected to be less than 1T.

TABLE 1

| normal | T | (pit length) | ON | OFF | ON | OFF | ON |
|---|---|---|---|---|---|---|---|
| normal | 11 | 261.8 | | | | | |
| normal | 10 | 238 | | | | | |
| normal | 9 | 214.2 | | | | | |
| normal | 8 | 190.4 | | | | | |
| normal | 7 | 156.6 | | | | | |
| normal | 6 | 142.8 | | | | | |
| normal | 5 | 119 | | | | | |
| normal | 4 | 95.2 | | | | | |
| normal | 3 | 71.4 | | | | | |

TABLE 2

| write strategy | T | (pit length) | ON | OFF | ON | OFF | ON |
|---|---|---|---|---|---|---|---|
| write strategy | 11 | 261.8 | 3T | 1T | 3T | 1T | 3T |
| write strategy | 10 | 238 | 2.7T | 0.9T | 2.8T | 0.9T | 2.7T |
| write strategy | 9 | 214.2 | 2.5T | 0.8T | 2.4T | 0.8T | 2.5T |
| write strategy | 8 | 190.4 | 2.1T | 0.8T | 2.2T | 0.8T | 2.1T |
| write strategy | 7 | 166.6 | 1.8T | 0.8T | 1.8T | 0.8T | 1.8T |
| write strategy | 6 | 142.3 | 1.6T | 0.7T | 1.4T | 0.7T | 1.6T |
| write strategy | 5 | 119 | 1.3T | 0.6T | 1.2T | 0.6T | 1.3T |
| write strategy | 4 | 95.2 | 1T | 0.5T | 1T | 0.5T | 1T |
| normal | 3 | 71.4 | | | | | |

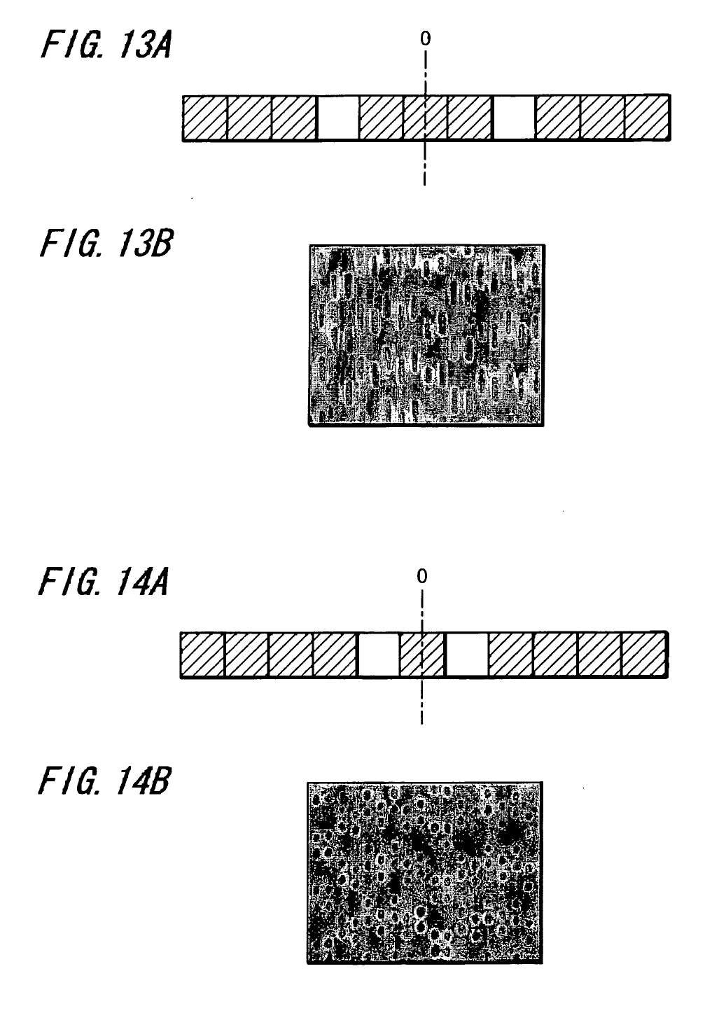

Examined results concerning the lengths of a plurality of pulses constituting respective concavities and convexities in the manufacturing method of the stamper master disc to produce the optical recording medium according to the present invention will be described with reference to FIGS. 13A, 13B, FIGS. 14A, 14B and FIGS. 15A, 15B wherein the longest pit (11T) is formed by way of example.

First, as shown in FIG. 13A, in an optical recording medium produced from a master disc manufactured by a symmetric pulse exposure pattern of 11T=3T(ON)−1T(OFF)−3T(ON)−1T(OFF)−3T(ON) which is symmetric to a dot-and-dash line O, the pits could be formed relatively stably as shown in FIG. 13B.

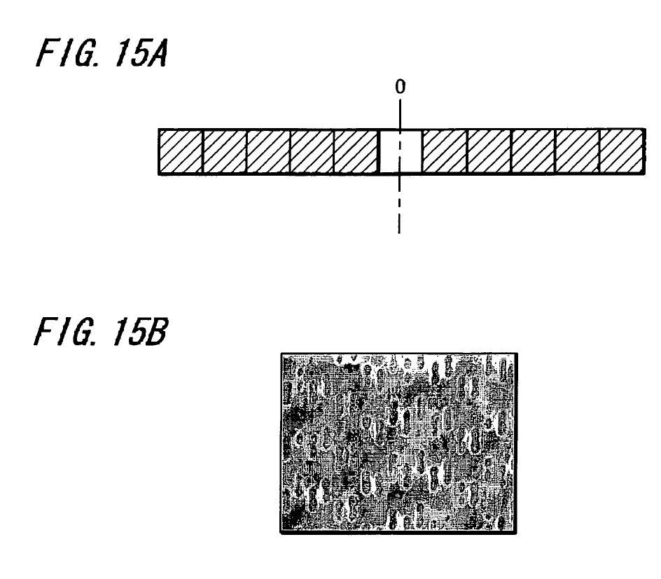

On the other hand, as shown in FIG. 14A, when the optical recording medium was produced from the master disc manufactured by a pulse exposure pulse pattern of 11T=4T(ON)−1T(OFF)−1T(ON)−1T(OFF)−4T(ON), the respective pits were divided completely as shown in FIG. 14B. Also, as shown in FIG. 15A, when the optical recording medium was produced from the master disc manufactured by a pulse exposure pulse pattern of 11T=5T(ON)−1T(OFF)−5T(ON), the pit shapes were not stable as shown in FIG. 15B. When the pulse strategy is designed in the longitudinal direction of the pits, that is, in the direction symmetric to the time base direction of exposure and reproducing light irradiation, if each pulse length has a length exceeding the shortest pit length 3T, then it could be confirmed that an optical recording medium having proper pit shape may not be obtained.

The embodiments of the manufacturing method of the stamper master disc to produce the optical recording medium according to the present invention have been described so far. According to the manufacturing method of the present invention, concavities and convexities corresponding to the pits of the finally obtained optical recording medium can be formed by the recording compensation exposure pulse based on a plurality of exposure pulses symmetric to the longitudinal direction, whereby the widths of the concavities and convexities of the stamper master disc can be made substantially constant.

Also, it can be considered that, when the exposure, that is, the voltage required to irradiate electron beams is made constant, the exposure pulse is selected to be less than the shortest recording pit length in the optical recording medium standard and the exposure pulse interval is selected to be less than ⅓ of the width of the shortest recording pit, in particular, the widths of concavities and convexities of the stamper master disc can be substantially made constant. Thus, since a difference between the pit widths of the finally obtained optical recording medium can be decreased, the problems such as the pattern failure, the deterioration of jitter and the increase of the error rate can be decreased.

The manufacturing method of the stamper master disc to produce the optical recording medium according to the present invention is not limited to the above-mentioned embodiments.

For example, while the voltage at which electron beams are irradiated is made constant in the above-mentioned embodiments, when it is intended to make the widths of the pulses constituting respective concavities and convexities uniform more strictly, other method may be devised to form concavities and convexities by setting a voltage to be high relative to a shorter pulse length in advance.

Further, while the chemically amplified resist is the positive type resist as set forth in the above-mentioned embodiments, the present invention is not limited thereto and various modifications and variations are also possible in such a way as to manufacture a stamper master disc by using a negative type resist.

According to the manufacturing method of a stamper master disc to produce an optical recording medium of the present invention, since the concave and convex pattern corresponding to the pits of the finally obtained optical recording medium is formed by recording compensation exposure pulses based on a plurality of pulses symmetric to the longitudinal direction, the width of the concave and convex pattern of the stamper master disc can be made substantially constant regardless of the length of the pit.

Also, when this concave and convex pattern is formed, since the voltage to make exposure, that is, the voltage required by electron beam irradiation is made constant, the exposure pulse is selected to be less than the shortest recording pit length of the standards of the recording medium and the exposure pulse interval is selected to be less than ⅓ of the width of the shortest recording pit, it is possible to especially properly form the concave and convex pattern by which the recording pit of target size and shape can be formed accurately.

Accordingly, since a difference between the pit widths of the finally obtained optical recording medium can be decreased, it is possible to decrease the problems such as the pattern failure, the increase of the asymmetry of the reproduced signal, the deterioration of the jitter and the increase of the error rate.

Also, according to the manufacturing method of the stamper master disc to produce the optical recording medium of the present invention, when the chemically amplified resist formed on the surface of the substrate of the stamper master disc is used as the etching mask to form concavities and convexities corresponding to the pits of the finally obtained optical recording medium on the substrate surface and a dry etching process based on a RIE (Reactive Ion Etching) method is applied to the optical recording medium thus obtained by this master disc, it is possible to alleviate a difference produced between the decreased widths of degree of modulations due to the lengths of the pits by methods such as to make the lengths of pulses constructing respective concavities and convexities become uniform or to set a voltage to be high in advance with respect to a shorter pulse to increase the width of the pulse.

Accordingly, it is possible to avoid a difference from being produced between the characteristics of the pits due to the difference of the pit length not only in the process for forming the pits but also in the process required after the pits were formed.

More specifically, in the exposure conditions and the heating conditions, when the conditions for making the shortest pit and the longest pit become compatible with each other are discovered, it is possible to sufficiently suppress a difference of characteristics from being produced due to the difference between the pit lengths with application of the present invention. As a result, the increase of the asymmetry of the reproduced signal, the deterioration of the jitter and the increase of the error rate can be improved and hence many important effects can be achieved by the manufacturing method of the present invention.

It should be understood by those skilled in the art that various modifications, combinations, sub-combinations and alterations may occur depending on design requirements and other factors insofar as they are within the scope of the appended claims or the equivalents thereof.

1. A manufacturing method of a stamper master disc to produce an optical recording medium on which concave and convex patterns including at least information pits are formed, comprising the steps of:
a resist layer forming process for forming an electron beam photosensitive type chemically amplified resist layer on a substrate;
an electron beam irradiation process for exposing said resist layer with irradiation of electron beams of an electron beam lithography pattern corresponding to said concave and convex patterns; and
a developing treatment process for patterning said chemically amplified resist layer by developing said chemically amplified resist layer, wherein electron beam lithography with respect to at least a part of said pits of said concave and convex pattern in said electron beam irradiation process is carried out by recording compensation exposure pulse based on a plurality of exposure pulses symmetrical to a center of the longitudinal direction of said pit.

2. A manufacturing method of a stamper master disc to produce an optical recording medium according to claim 1, wherein said exposure pulse in said electron beam irradiation has a constant voltage.

3. A manufacturing method of a stamper master disc to produce an optical recording medium according to claim 1 or 2, wherein said electron beam irradiation process is carried out by using a local vacuum electron beam lithography system.

4. A manufacturing method of a stamper master disc to produce an optical recording medium according to claim 1 or 2, wherein said exposure pulse is less than a shortest recording pit length.

5. A manufacturing method of a stamper master disc according to claim 1 or 2, wherein said exposure pulse has a space less than ⅓ of a shortest recording pit width.
